(19) United States
(12) Patent Application Publication
(10) Pub. No.: US 2009/0070430 A1
(43) Pub. Date: Mar. 12, 2009

(54) SYSTEM AND METHOD FOR NOTIFYING LEGAL STATUS OF PATENTS

(75) Inventors: CHUNG-I LEE, Tu-Cheng (TW); CHIEN-FA YEH, Tu-Cheng (TW); DA-PENG LI, Shenzhen City (CN); HUI-MIN YU, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/189,124

(22) Filed: Aug. 8, 2008

(30) Foreign Application Priority Data
Sep. 7, 2007 (CN) 200710201623.5

(51) Int. Cl. G06F 15/16

(52) U.S. Cl. 709/206

(57) ABSTRACT

A method for notifying a legal status of a patent is disclosed. The method includes: setting notification parameters, the notification parameters including one or more patent numbers and/or patent application numbers and an assignee information; downloading a new legal status of patents in a database from the patent office website and updating the legal status of the patents in the database if the patent office website has issued new legal status of the patent; sending a message including the updated legal status to assignee according to the assignee information, if the updated legal status are of the one or more patents and/or patent applications.

### BACKGROUND OF THE INVENTION

1. Field of the Invention

Embodiments of the present disclosure relate to notifying legal status of patents, and more particularly to systems and methods for notifying legal status of patents.

2. Description of related art

Patent professionals often search for publications relevant to patents. Searches typically arise in two contexts: when looking for “prior art” publications that might invalidate a patent and when looking for publications that might disclose an infringement of a patent.

An ever-increasing number of publications are being published on the Internet, for example, “white papers” published on companies' public websites. Thus, the Internet has become a more and more important resource for patent professionals looking for publications relevant to legal status of patents. However, patent professionals have for the most part relied on general Internet search techniques, such as applying keywords to general-purpose Internet search engines, to discover legal status of patent-relevant publications on the Internet.

Therefore, what is also needed is a system and method for notifying legal status of patents, which can be used for notifying legal status of patents to user and timely.

### SUMMARY

A system for notifying legal status of patents is provided. The system includes a setting module, a determining module, a downloading module, a sending module. The setting module configured for setting notification parameters for the patent, the notification parameters comprising one or more patent numbers and/or patent application numbers and an assignee information for the one or more patent numbers and/or patent application numbers. The determining module configured for detecting if a designated patent office website has issued new legal status of the patent, and if the updated legal status are of the one or more patents and/or patent applications. The downloading module configured for downloading a new legal status of the patent in a database from the patent office website and updating the legal status of the patent in the database if the patent office website has issued the new legal status of the patent. The sending module configured for sending a message including the updated legal status of the patent to assignee according to the assignee information if the updated legal status are of the one or more patents and/or patent applications. At least one processor executing the setting module, the determining module, the downloading module, and the sending module.

Other advantages and novel features will become more apparent from the following detailed description certain embodiments of the present disclosure when taken in conjunction with the accompanying drawings, in which:

### BRIEF DESCRIPTION OF THE DRAWINGS

FIG. 1 is a block diagram of hardware configuration of a system for notifying legal status of patents in accordance with one embodiment of present disclosure;

FIG. 2 is a block diagram of one embodiment of main function modules of an application server of FIG. 1; and

FIG. 3 is a flowchart of one embodiment of a method for notifying legal status of patents in accordance with the present disclosure.

### DETAILED DESCRIPTION OF CERTAIN INVENTIVE EMBODIMENT

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

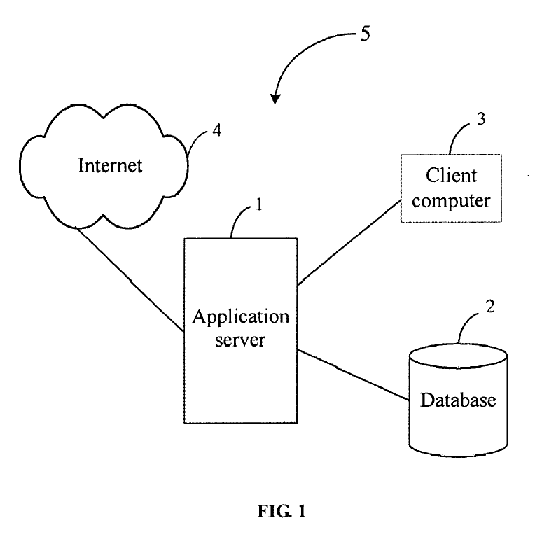

FIG. 1 is a block diagram of hardware configuration of a system 5 for notifying legal status of patents in accordance with one embodiment of the present disclosure. In one embodiment, the system 5 includes an application server 1 and a database 2. The application server 1 can access one or more patent websites via the Internet 4, and can download legal status of patents from the patent websites. The application server 1 may also connect to a database 2. The database 2 is configured for storing information regarding legal status of patents from the one or more patent websites. One or more client computers 3 (only one shown) connect to the application server 1, and each is used for providing an operation interface to user.

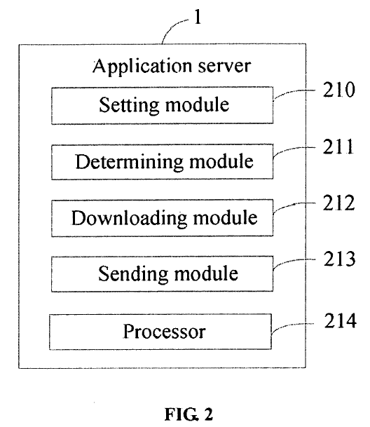

FIG. 2 is a block diagram of one embodiment of main function modules of the application server 1. In one embodiment, the application server 1 includes a setting module 210, a determining module 211, a downloading module 212, a sending module 213, and a processor 214.

The setting module 210 is configured for setting notification parameters notifying a legal status of a patent application. The parameters include one or more monitored patent numbers and/or patent application numbers and assignee information. In one exemplary embodiment, assignee information includes a name and an e-mail address of the assignee. The legal status of a patent includes, for example, if the patent is invalidated or in effect, and/or if the patent has been paid or not been paid.

The determining module 211 is configured for detecting if a designated patent office website has issued new legal status for one or more patents. Depending on the embodiment, the patent website may comprise the United States Patent and Trademark Office (USPTO) Website, the European Patent Office (EPO) website, the State Intellectual Property Office of P.R China (SIPO) website, the Taiwan Intellectual Property Office (TIPO) website, for example.

The downloading module 212 is configured for downloading new a legal status of a patent from a database 2 from the patent office website and updating the legal status of the patents in the database if the patent office website has issued new legal status of the patent.

The determining module 211 is also configured for determining if the updated legal status are of one or more patents and/or patent applications that are being monitored by the system 5.

The sending module 213 is configured for sending a message including the updated legal status to assignee according to the assignee information and generating a tag. The tag is used for determining if the message has been sent to the assignee successfully. The application server 1 resends the message if the message including updated legal status has not been sent to the assignee.

The determining module 211 is also configured for determining if the message has been sent to the user successfully according to the tag.

It may be understood that one or more specialized or general purpose processors, such as a processor 214, in the application server 1 may be used to execute computerized code in the setting module 210, the determining module 211, the downloading module 212, and the sending module 213.

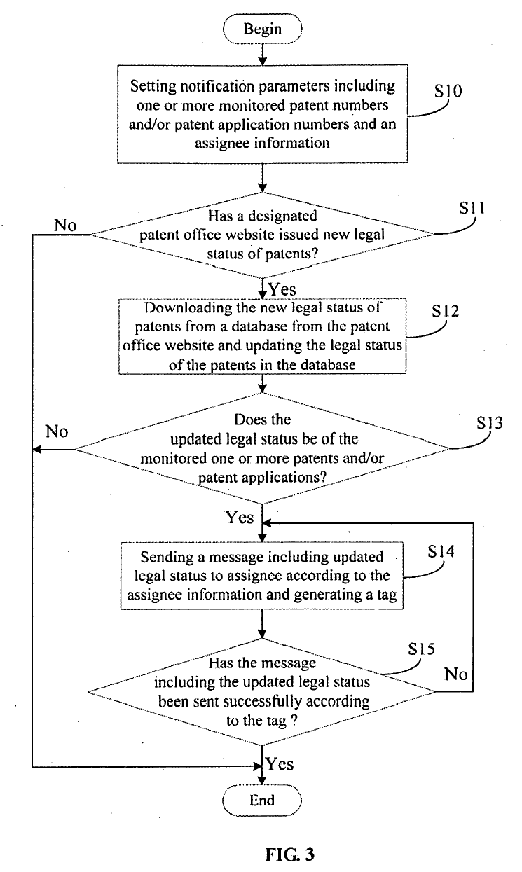

FIG. 3 is a flowchart of one embodiment of a method for notifying legal status of patents in accordance with the present disclosure. In block S10, a user sets notification parameters for one or more patent numbers and/or patent applications monitored by the system 5. In the one exemplary embodiment, assignee information includes a name and an E-mail address of the assignee. The legal status of a patent includes, for example, if the patent is invalidated or in effect, and/or if the patent has been paid or not been paid.

In block S11, the determining module 211 detects if a designated patent office website has issued new legal status of patents. As mentioned above, the patent office website could comprise many patent office websites of varying countries.

If the patent office website has not issued new legal status of patents, the procedure ends. Otherwise, if the patent website has issued new legal status of patents, in block S12, the downloading module 212 downloads new legal status of patents in a database 2 from the patent office website and updating the legal status of the patents in the database if the patent office website has issued new legal status of patents.

In block S13, the determining module 211 also determines if the updated legal status are of the monitored one or more patents and/or patent applications.

If the updated legal status are not of the legal status of the monitored one or more patents and/or patent applications, the procedure ends. Otherwise, if the updated legal status are of the legal status of the monitored one or more patents and/or patent applications, in block S14, the sending module 213 sends a message including the updated legal status to assignee according to the assignee information and generating a tag. As mentioned above, the tag is used for determining if the message including updated legal status has been sent to the assignee successfully. The application server 1 resends the message if the message including the updated legal status has not been sent to the assignee.

In block S15, the determining module 211 also determines whether the message including the updated legal status has been sent to the user successfully according to the tag.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for notifying a legal status of a patent, the system comprising:
a setting module configured for setting notification parameters for the patent, the notification parameters comprising one or more patent numbers and/or patent application numbers and an assignee information for the one or more patent numbers and/or patent application numbers;
a determining module configured for detecting if a designated patent office website has issued new legal status of the patent, and if the updated legal status are of the one or more patents and/or patent applications;
a downloading module configured for downloading a new legal status of the patent in a database from the patent office website and updating the legal status of the patent in the database if the patent office website has issued the new legal status of the patent;
a sending module configured for sending a message including the updated legal status of the patent to assignee according to the assignee information if the updated legal status are of the one or more patents and/or patent applications; and
at least one processor executing the setting module, the determining module, the downloading module, and the sending module.

2. The system as claimed in claim 1, wherein the assignee information includes a name and an e-mail address of the assignee.

3. The system as claimed in claim 2, wherein the sending module is further configured for generating a tag for determining if the application server has sent the message including the updated legal status to assignee successfully.

4. A computer-based method for notifying a legal status of a patent, the method comprising:
setting notification parameters comprising one or more patent numbers and/or patent application numbers and an assignee information for the one or more patent numbers and/or patent application numbers;
downloading a new legal status of the patent in a database from the patent office website and updating the legal status of the patent in the database if the patent office website has issued the new legal status of the patent; and
sending a message including the updated legal status of the patent to assignee according to the assignee information if the updated legal status are of the one or more patents and/or patent applications.

5. The method as claimed in claim 4, wherein the assignee information includes a name and an e-mail address of the assignee.

6. The method as claimed in claim 4, further comprising generating a tag for generating a tag for determining if the application server has sent the message including the legal status to assignee successfully.
